(19) United States
(12) Patent Application Publication
(10) Pub. No.: US 2010/0140967 A1
(43) Pub. Date: Jun. 10, 2010

(54) Motor Vehicle

(75) Inventor: Mario List, Remseck (DE)

Correspondence Address: CROWELL & MORING LLP;INTELLECTUAL PROPERTY GROUP, P.O. BOX 14300, WASHINGTON, DC, 20044-4300, US

(73) Assignee: Daimler AG, Stuttgart (DE)

(21) Appl. No.: 11/993,642

(22) PCT Filed: Jun. 14, 2006
(86) PCT No.: PCT/EP06/05704

§ 371 Date: Feb. 26, 2010

(30) Foreign Application Priority Data
Jun. 22, 2005 (DE) 10 2005 028 770.0

(51) Int. Cl. B60R 19/26; B62D 33/06; B62D 25/20

(52) U.S. Cl. 293/132; 296/190.01; 296/193.07

(57) ABSTRACT

The invention relates to a motor vehicle, in particular a utility vehicle, with a driver's cab (2) which has a driver's cab floor (4). In order to improve occupant protection, the driver's cab floor (4) has, in the front region (3) of the motor vehicle, at least one receiving space (14) for at least one crash element (16).

This application is a national stage of PCT International Application No. PCT/EP2006/005704, filed Jun. 14, 2006, which claims priority under 35 U.S.C. §119 to German Patent Application No. 10 2005 028 770.0, filed Jun. 22, 2005, the disclosure of which is expressly incorporated by reference herein.

### BACKGROUND AND SUMMARY OF THE INVENTION

The invention relates to a motor vehicle with a driver's cab which has a driver's cab floor that includes an energy absorbing structure.

German patent document DE 103 36 200 A1 discloses a driver's cab for a utility vehicle with two hollow profile supports which are connected to and supported on a support structure in such a manner that, in response to forces acting on the leading front, the hollow profile supports transmit forces into the support structure. A crash element which extends between both hollow profile supports is at least partially arranged in front of both hollow profile supports.

German patent document DE 102 54 693 A1 discloses a front structure for a motor vehicle which has two longitudinal supports and two crash box elements. Two connecting supports are provided which connect the longitudinal supports to the associated crash box element, the connecting supports being constructed from an inner shell and an upper and a lower shell, respectively.

German patent document DE 38 27 923 A1 discloses a frame for motor vehicles with an energy-consuming front part that has at least two support parts at the front end of each longitudinal support which diverge in a forward direction approximately V-shaped starting from the front longitudinal support end and are connected at the front to a front transverse support.

German patent document DE 199 59 701 A1 discloses an energy absorbing device for a motor vehicle, which has a box profile of sheet metal construction fastened to at least one bodywork component. The box profile is formed in the direction of introduction of a force to be received, with such a conical expansion that, in the event of a compression by an incident force, the deformed material substantially accumulates within the cross-section of the remaining deformation length of the box profile at least approximately in a folded manner.

German patent document DE 198 49 358 C2 discloses a fender for a motor vehicle with a bending support which can be fixed transverse to the longitudinal supports of the motor vehicle. The fender is formed by a deformed tube with a central portion which is resistant to bending and deformation portions at the end. The central portion has a bead running in its longitudinal extension which is arranged on the face facing away from the motor vehicle, and the cross-section in the deformation sections is larger than the cross-section in the central portion.

Finally, German patent document DE 101 24 271 A1 discloses a support structure of a driver's cab of a utility vehicle with longitudinal supports arranged below a floor plate belonging to the floor group. The longitudinal supports are connected to one another by at least one transverse support, extend upwards at an angle beyond the floor plate. The free ends of the upwards protruding longitudinal support portions are connected to the transverse support.

One object of the present invention is to improve occupant protection in a motor vehicle, such as a utility vehicle having a driver's cab and a driver's cab floor.

This and other objects and advantages are achieved by the motor vehicle according to the invention, in particular a utility vehicle with a driver's cab which has a driver's cab floor. The driver's cab floor has, in the front region of the motor vehicle, at least one receiving space for at least one crash element. As a result of this arrangement, kinetic energy can be converted into deformation energy in the case of an only small elongation of the driver's cab, in a simple manner, for example, in the case of a rear end collision. This conversion is achieved by plastic deformation of the crash element and/or a receiving space if the crash element moves into the latter in the event of a collision.

In a preferred exemplary embodiment of the motor vehicle, the driver's cab floor includes a driver's cab floor upper part and at least one driver's cab floor lower part which delimit the receiving space for the crash element. The driver's cab floor is therefore formed by at least two shells.

In a further embodiment of the motor vehicle according to the invention, the driver's cab floor encompasses a longitudinal support with a hollow space which forms the receiving space for the crash element. The longitudinal support is preferably formed by driver's cab floor parts. The receiving space for the crash element can, however, also be provided in a longitudinal frame support or in or on other force-receiving elements of the vehicle support structure on which the driver's cab floor is mounted.

According to a further embodiment, the receiving space for the crash element is adapted to the cross-section of the crash element. This cross-section can, for example, be rectangular or cylindrical, but other cross-sections can also be represented.

According to a further feature of the motor vehicle, the crash element tapers in the longitudinal direction of the vehicle, for example, in the shape of a truncated cone. In the event of an accident, the crash element moves in the longitudinal direction of the vehicle, and wedges into the receiving space. The conversion of kinetic energy can be performed in several steps. On the one hand, the crash element can deform in the longitudinal direction and/or in the transverse direction. On the other hand, the vehicle parts delimiting the receiving space, in particular driver's cab floor parts, can also yield in a defined manner.

According to a further preferred feature of the invention, the crash element is wedge-shaped, and is preferably formed by a wedge-shaped hollow profile which can also, for example, be foamed with plastic where required.

In a further embodiment of the invention, the dimensions and the shape of the crash element are selected so that the crash element moves into the receiving space in the event of an accident (in particular, a rear end collision), and the crash element and/or the receiving space deforms plastically. Kinetic energy of the motor vehicle is converted into deformation energy as a result of plastic deformation. The crash element preferably moves in the longitudinal direction of the vehicle in order to convert kinetic energy into deformation energy.

In still a further embodiment, the driver's cab floor has at least two receiving spaces for respectively at least one crash element. At least one crash element is preferably arranged at each lateral end of the front region.

According to a further feature of the invention, both receiving spaces are arranged symmetrically in the front region of the motor vehicle. The symmetrical arrangement to the longitudinal axis of the vehicle has proved to be particularly advantageous in the context of the present invention.

In a further embodiment of the motor vehicle, the crash elements received in the receiving spaces are coupled to one another by a bending support, which is also preferably embodied as a crash element. The bending support can, for example, be foamed with a deformable plastic.

Other objects, advantages and novel features of the present invention will become apparent from the following detailed description of the invention when considered in conjunction with the accompanying drawings.

### BRIEF DESCRIPTION OF THE DRAWINGS

FIG. 1 shows the front region of a utility vehicle according to a first exemplary embodiment of the invention;

FIG. 2 shows the front region of a utility vehicle according to a second exemplary embodiment of the invention;

FIG. 3 is a schematic perspective representation of a driver's cab floor with two crash elements which are coupled to one another by a bending support;

FIG. 4 shows a receiving space for a crash element according to a further exemplary embodiment in cross-section; and

FIG. 5 shows a receiving space for a crash element according to a further exemplary embodiment in cross-section.

### DETAILED DESCRIPTION OF THE DRAWINGS

The front part of a motor vehicle 1 is schematically shown in a side view in FIG. 1. Motor vehicle 1 is a utility vehicle, in particular a truck with hood, which includes a driver's cab 2 with a front region 3. Driver's cab 2 is delimited at the bottom by a driver's cab floor 4, a drive unit 5 being arranged below driver's cab floor 4. In the case of trucks with hood, at least a part of the engine is arranged in front of the driver's cab. Drive unit 5 can be coupled to a wheel 6 which is mounted on a front axis 7.

Driver's cab floor 4 comprises an upper part 11 and a lower part 12. A longitudinal receiving space 14 for a wedge-shaped crash element 16 is formed between driver's cab floor upper part 11 and driver's cab floor lower part 12. In the event of an accident, crash element 16 displaces into receiving space 14. Driver's cab floor 4 formed in two parts or two shells is also referred to as a sandwich floor. Crash element 16 is part of a crash structure 18 which encompasses beads 21 to 24 arranged in front of the crash element 16 as seen in the longitudinal direction of the vehicle. The crash structure 18 can reduce significantly occupant accelerations which occur in the event of a collision.

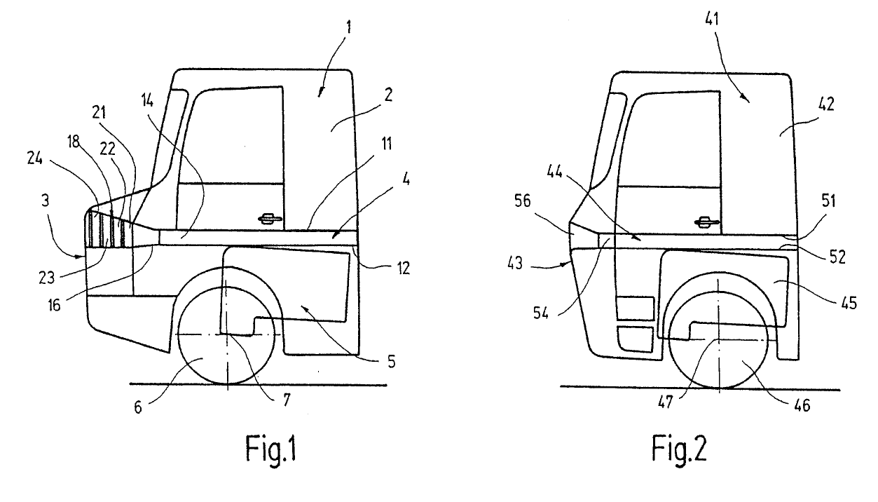

FIG. 2 is a schematic side view of the front part of a utility vehicle 41, according to a second embodiment of the invention, in which the utility vehicle 41 is a forward control type motor vehicle. Forward control type motor vehicle 41 encompasses a driver's cab 42 with a front region 43. Driver's cab 42 is delimited at the bottom by a driver's cab floor 44. A drive unit 45 is arranged below driver's cab floor 44, drive unit 45 being capable of being coupled in a driving manner with a wheel 6 which is mounted on a front axis 7.

Driver's cab floor 44 encompasses an upper part 51 and a lower part 52, with a longitudinal receiving space 54 for a wedge-shaped crash element 56 being formed therebetween. In the event of an accident, crash element 56 displaces into receiving space 54 in the longitudinal direction of the vehicle, and wedges between driver's cab floor parts 51 and 52.

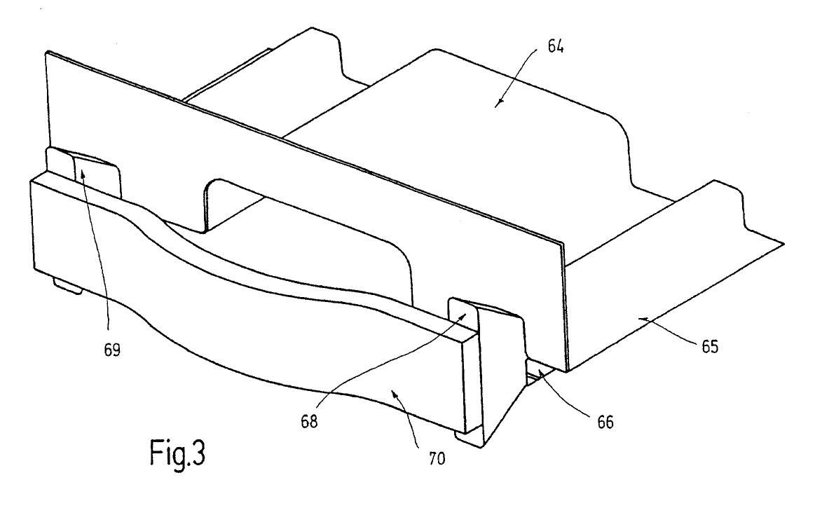

FIG. 3 is a schematic perspective view of a driver's cab floor 64 which comprises an upper part 65 and a lower part 66. Two wedge-shaped crash elements 68 and 69 arranged in front of driver's cab floor 64 are formed by wedge-shaped hollow profiles and are coupled to one another by a bending support 70, preferably embodied as a crash element. For this purpose, bending support 70 can be foamed or filled with other elements. It can also serve as a stabilizer for the driver's cab, and is supported in the event of an accident in a defined manner on the driver's cab floor or on a vehicle support structure, in particular on a chassis so that energy is introduced from the driver's cab into the chassis. In addition, further energy paths can also be provided from the driver's cab into the chassis.

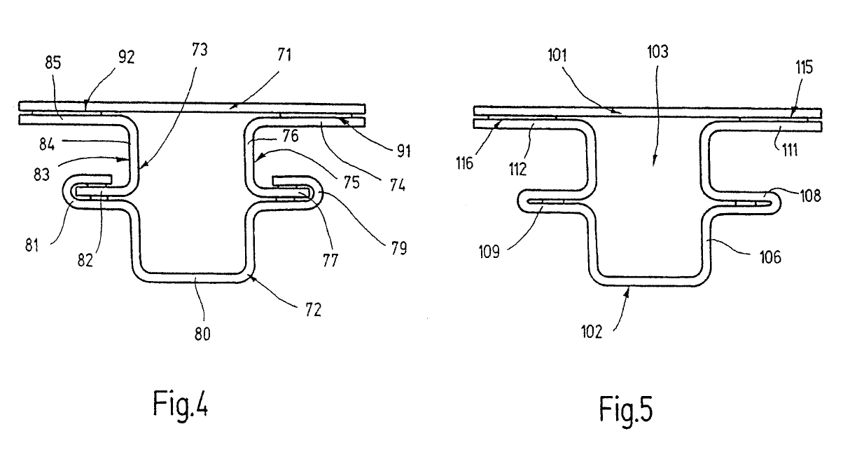

A portion of a driver's cab floor upper part 71, of which only a section is shown, is represented in cross-section in FIG. 4. A driver's cab floor lower part 72 is fastened on driver's cab floor upper part 71 via spacers 75 and 83. A receiving space 73, which has substantially a rectangular cross-section, for a crash element is formed between the upper and lower driver's cab floor parts 71 and 72.

Driver's cab floor lower part 72, which is also referred to as an angle profile or closing profile, is fastened on driver's cab floor upper part 71 via a branch 74 of a U-profile 75 (also referred to as a spacer), which has a base 76 from which a shorter limb 77 proceeds. Limbs 74 and 77 of U-profile 75 face away from receiving space 73. Shorter limb 77 of U-profile 75 is gripped around by a further U-profile 79 which forms a transition into a further U-profile 80.

Further U-profile 80 forms a transition into a further U-profile 81 which is designed in an analogous manner to U-profile 79 and grips around a shorter limb 82 of a U-profile 83 (also referred to as a spacer) which is designed analogous to U-profile 75. U-profile 83 has a base 84 arranged parallel to base 76 of U-profile 75. The limbs of U-profile 80 are arranged in elongation of bases 84 and 76 of U-profiles 83 and 75 and laterally delimit receiving space 73. The top of the receiving space 73 is delimited by driver's cab floor upper part 71, while the bottom is delimited by the base of U-profile 80. Analogous to U-profile 75, U-profile 83 has a longer branch 85 which is fastened on driver's cab floor upper part 71. Profiles 75, 83 and 72 together form a driver's cab floor lower part.

Connection points 91, 92 between driver's cab floor upper part 71 and driver's cab floor lower part 72 and further connection points between U-profile 81 and U-profiles 75 and 83 are formed as weld connection points. The individual parts can, however, also be connected to one another by clinching, riveting or other types of connection.

A driver's cab floor upper part 101 is shown in cross-section in FIG. 5. A single-piece driver's cab floor lower part 102 is fastened on driver's cab floor upper part 101. A receiving space 103, which has a substantially rectangular cross-section, for a crash element is formed between driver's cab floor parts 101 and 102. Driver's cab floor lower part 102 is formed by a rectangular profile 106 V from which two substantially U-shaped cross-sectional regions 108, 109 protrude laterally. The limbs of U-shaped regions 108, 109 are welded to one another, for example. Rectangular profile 106 is formed to be open towards driver's cab floor upper part 101 and is therefore also referred to as a U-profile. At its open end, the rectangular profile or U-profile 106 has two branches 111, 112 which are angled outwards, and are fastened on driver's cab floor upper part 101 by, for example, weld connections 115, 116.

The crash elements used in the present invention are preferably formed as wedge-shaped hollow profiles, but can also have the form of truncated cones, cylinders or the like. The crash elements (also referred to as crash wedges), can also be mounted on longitudinal frame supports or on other force-receiving elements of the vehicle support structure.

The energy absorbing arrangement according to the invention can increase the survivable speed in a driver's cab collision with a fixed barrier. At the same time, the risk of injury to the driver is reduced since the occupant acceleration, caused by the extended crash paths, can be reduced. Moreover, rapid changes are possible between various types of design (for example, between front control type vehicles, trucks with a short hood and vehicles with hood). As a result, a modular principle can be realized by which the range of models can be enlarged in a simple manner.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1.-10. (canceled)

11. A motor vehicle having a driver's cab that includes a driver's cab floor, wherein the driver's cab floor has, in a front region of the motor vehicle, at least one receiving space for at least one crash element.

12. The motor vehicle according to claim 11, wherein the driver's cab floor comprises an upper part and at least one lower part which delimit the receiving space for the crash element.

13. The motor vehicle according to claim 11, wherein the driver's cab floor comprises a longitudinal support with a hollow space which forms the receiving space for the crash element.

14. The motor vehicle according to claim 11, wherein the receiving space for the crash element has a cross section that is configured to receive a cross-section of the crash element.

15. The motor vehicle according to claim 11, wherein the crash element tapers in a longitudinal direction of the vehicle.

16. The motor vehicle according to claim 11, wherein the crash element is wedge-shaped.

17. The motor vehicle according to claim 11, wherein dimensions and shape of the crash element are selected such that the crash element is moveable into the receiving space in the event of an accident with at least one of the crash element and the receiving space deforming plastically.

18. The motor vehicle according to claim 11, wherein the driver's cab floor has at least two receiving spaces, each for receiving at least one crash element.

19. The motor vehicle according to claim 18, wherein both receiving spaces are arranged symmetrically in the front region of the motor vehicle.

20. The motor vehicle according to claim 18, wherein the crash elements received in the receiving spaces are coupled to one another by a bending support.

21. A vehicle cab comprising:
a floor structure that includes an upper floor element and a lower floor element, said upper and lower floor elements being spaced apart from each other, forming a receiving space therebetween; and
a crash element that is displaceable into said receiving space in response to an impact on said cab due to a collision;
wherein a relative size and shape of said crash element and said receiving space are such that displacement of said crash element into said receiving space causes at least one of said crash element and said receiving space to undergo a plastic deformation.
